(19) United States
(12) Patent Application Publication
(10) Pub. No.: US 2011/0229398 A1
(43) Pub. Date: Sep. 22, 2011

(54) FLUIDIZED BED REACTOR, THE USE THEREOF, AND A METHOD FOR THE ENERGY-INDEPENDENT HYDROGENATION OF CHLOROSILANES

(75) Inventors: Harald Troll, Alzenau (DE); Peter Adler, Rheinfelden (DE); Raymund Sonnenschein, Alzenau (DE)

(73) Assignee: EVONIK DEGUSSA GMBH, Essen (DE)

(21) Appl. No.: 13/062,431

(22) PCT Filed: Jul. 10, 2009
(86) PCT No.: PCT/EP2009/058790

§ 371 Date: May 31, 2011

(30) Foreign Application Priority Data
Sep. 10, 2008 (DE) 10 2008 041 974.5

(51) Int. Cl. C01B 33/107; F27B 15/14; B01J 8/18

(52) U.S. Cl. 423/342; 422/146; 422/119

(57) ABSTRACT

The present invention relates to a device, to the use thereof, and to a method for the substantially energy-independent continuous production of chlorosilanes, particularly for the production of trichlorosilane as an intermediate product for yielding high-purity silicon.

The present invention relates to an apparatus, the use thereof and a process for substantially energy-independent continuous preparation of chlorosilanes, in particular for the preparation of trichlorosilane as an intermediate for obtaining high-purity silicon.

Trichlorosilane, in particular in pure form, is now an important starting material inter alia for the production of high-purity silicon, for example for the production of chips or solar cells (WO 02/48034, EP 0 921 098).

Unfortunately, the known processes are complicated and energy-intensive. Thus, attempts have been made to prepare the material more and more economically in spite of very high quality requirements.

It has long been known that chlorosilanes can be prepared in a fluid bed or fluidized bed reactor from metallurgical silicon (Si) with addition of hydrogen chloride (HCl) or methyl chloride (inter alia U.S. Pat. No. 4,281,149).

The reaction of silicon with HCl is highly exothermic. As a rule, trichlorosilane (TCS) and silicon tetrachloride (STC) are obtained as main products. Furthermore, the use of special materials for producing the reactor should be taken into account (DE 36 40 172).

Attention is also being paid to the selectivity of the reactions. Thus, the reactions can be influenced by the presence of more or less suitable catalysts. Inter alia, Fe, Cr, Ni, Co, Mn, W, Mo, V, P, As, Sb, Bi, O, S, Se, Te, Ti, Zr, C, Ge, Sn, Pb, Cu, Zn, Cd, Mg, Ca, Sr, Ba, B, Al, Y, Cl are mentioned in the literature as examples of these. As a rule, such catalysts are already present in the metallurgical silicon, for example in oxidic or metallic form, as silicides or in other metallurgical phases. Moreover, catalysts may be added or may be present in said reactions in metallic or alloyed or salt-like form. Thus, the wall or surface material of the reactor used can also have a catalytic influence in the reaction (inter alia B. Kanner and K. M. Lewis “Commercial Production of Silanes by the direct Synthesis”, pages 1-66, Studies in Organic Chemistry 49, Catalyzed Direct Reactions of Silicon, edited by K. M. Lewis and D. G. Rethwisch, 1993, Elsevier Science Publishers; H. Samori et al., “Effects of trace elements in metallurgical silicon on trichlorosilane synthesis reaction”, Silicon for the chemical industry III, Sandefjord, Norway, Jun. 18-20, 1996, pages 157-167; J. Acker et al., “Formation of silicides in the system Metal-Silicon-Chlorine-Hydrogen: Consequences for the synthesis of trichlorosilane from silicon an hydrogen chloride”, Silicon for the chemical industry, Tromso, Norway, May 29-Jun. 2, 2000, pages 121-133; W. C. Breneman et al., “A comparison of the Trichlorosilane and silane routes in the purification of metallurgical grade silicon to semiconductor quality”, Silicon for the chemical industry IV, Geiranger, Norway, Jun. 3-5, 1998, pages 101-112; WO 03/018207, WO 05/003030).

Another possibility for the preparation of trichlorosilane is the thermal conversion of silicon tetrachloride and hydrogen in the gas phase in the presence or absence of a catalyst. This synthesis route is likewise very energy-intensive since the reaction takes place endothermically (DE 10 2006 050 329, DE 10 2005 046703).

It is also possible to react metallurgical silicon with silicon tetrachloride and hydrogen (DE 33 11 650) or silicon with silicon tetrachloride, hydrogen and HCl (DE 100 63 863, DE 100 44 795, DE 100 44 794, DE 100 45 367, DE 100 48 794, DE 100 61 682). The reactions are carried out as a rule under pressure and at high temperature. Furthermore, these processes too require the supply of energy, which as a rule is effected electrically and is increasingly becoming a cost factor. Silicon, silicon tetrachloride and hydrogen or silicon, silicon tetrachloride, hydrogen and hydrogen chloride as starting components have to be metered into the reactor under reaction conditions of from 20 to 42 bar and from 400 to 800° C. and the reaction has to be started and kept running.

In the case of an interruption of operation, it is also necessary to keep the starting materials or starting material feed at the required operating pressure and temperature in standby operation in order to be able to start up again or to continue operation without long heating up times.

Thus, it was an object to provide a further, very economical possibility for the industrial, continuous reaction of silicon (Si), silicon tetrachloride (STC, SiCl₄), hydrogen (H₂) and optionally hydrogen chloride (HCl) and if desired further components in order to alleviate the abovementioned problems.

A particular concern of the present invention was to provide trichlorosilane (TCS, HSiCl₃) in as energy-saving and economical manner as possible for an integrated system for the preparation of high-purity silicon, chloro- or organosilanes and organosiloxanes and pyrogenic silica.

This object is achieved, according to the invention, in accordance with the information in the patent claims.

Thus, it was surprisingly found that the reaction of particulate Si, chlorosilanes, in particular SiCl₄, and H₂ and optionally in the presence of at least one catalyst at a pressure of from 25 to 55 bar and a temperature from 450 to 650° C. can be carried out in a particularly energy-saving and hence economical manner if gas-fired burners, in particular natural gas burners, are used for heating the STC stream and the start-up process of the reactor and regulation or control when carrying out the present process.

Thus, particularly in the case of hydrogenation of SiCl₄ in the present process, the necessary reaction energy can advantageously be supplied in a simple and particularly economical manner via the reactor heating.

In addition, by targeted introduction of HCl and/or Cl₂ gas, it is possible to carry out the reaction or present conversion exothermally. Furthermore, excess quantity of heat can be removed via the reactor thermostatting and, by means of heat exchangers, advantageously used, for example, for preheating the starting material gases. Thus, HCl and/or Cl₂ can be introduced or metered in a targeted manner into the fluidized bed reactor in order to regulate energy input for the start-up or for maintaining the present conversion or reactions in an advantageous energy-saving manner.

When carrying out the present process, at least one catalyst can also advantageously be used. A catalyst system based on at least one transition metal element, is preferably chosen, particularly preferably at least one metal from the series consisting of Fe, Co, Ni, Cu, Ta, W, for example in the form of the chlorides, such as FeCl₂, CuCl, CuCl₂, etc., and/or corresponding metal silicides or mixtures thereof, particularly preferably a copper-containing catalyst system.

Furthermore, the present process and the plant developed for this purpose, in particular the novel fluidized bed plant, and such a plant advantageously incorporated into so-called integrated systems for the preparation of chlorosilanes, silanes, organosilanes, organosiloxanes, pyrogenic and precipitated silica and solar silicon can particularly advantageously be carried out or operated industrially in a particularly economical, continuous procedure.

The present invention therefore relates to a fluidized bed reactor for the continuous hydrogenation of higher chlorosilanes of the formula HₙSiCl₄₋ₙ where n=0, 1, 2 or 3 in the presence of silicon, in particular for the preparation of chlorosilanes by reacting substantially silicon (A), silicon tetrachloride (B), hydrogen (C) and optionally hydrogen chloride gas and/or chlorine gas (D) and optionally in the presence of a catalyst at a pressure of from 25 to 55 bar and a temperature of from 450 to 650° C., the fluidized bed reactor unit (1) being based on
a reactor or reactor casing (1.1) having a jacket (1.2) for cooling or warming or heating the reactor and a heat exchanger unit (1.3) arranged parallel to the longitudinal axis of the reactor and in the reactor interior, it being possible for a gaseous medium (F) to flow through the units (1.2) and (1.3) and it being possible for the medium (F) to be heated by means of gas-fired heat exchangers (1.11),
at least one bottom feed (1.4) for chlorosilane- or STC-containing starting material stream (B*),
at least one feed (1.5) for one or more gaseous starting materials from the series (C) and (D),
at least one (solid) feed (1.6) for particulate silicon (A) with which, if desired, catalyst is mixed, and
removal and separation for product (G, H) via reactor top, dust filter (1.7) and condenser (1.8).

The waste heat from the units (1.2) and (1.3), transported via the pipes (1.14) to the heat exchanger (1.10) (so-called hot-gas recuperator), can advantageously be used, for example, for preheating gas streams (F) and/or, by means of heat exchanger (1.5.5), for preheating (C) and/or (D) containing gas streams. Thus, the waste heat of the plant units can advantageously additionally be used in a particularly energy-efficient manner for starting the reaction and maintaining and controlling it in the fluidized bed reactor according to the invention.

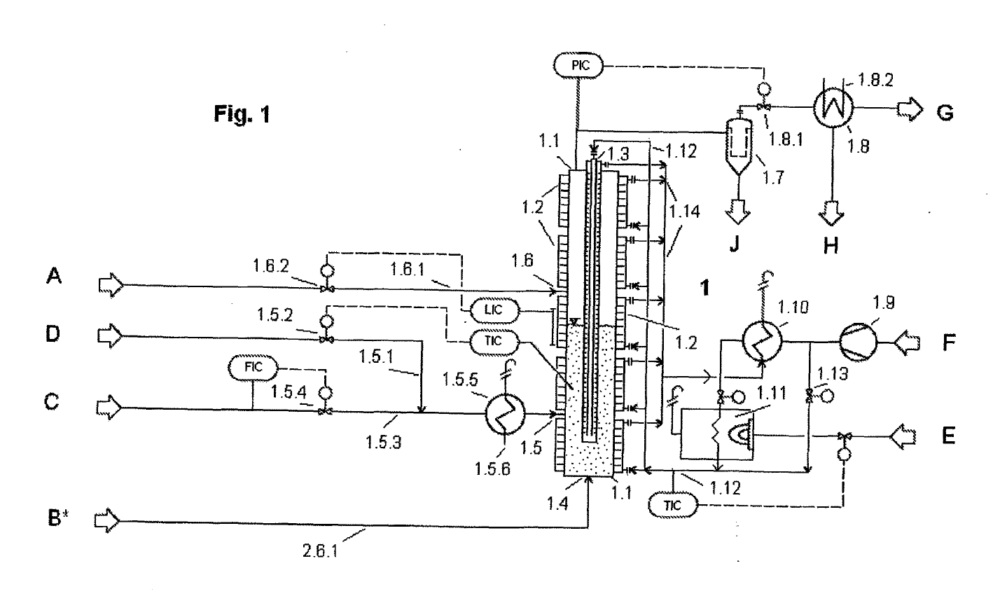

FIG. 1 shows a preferred embodiment of the fluidized bed reactor according to the invention.

A reactor casing (1.1) having an internal diameter of from 100 mm to 2000 mm and a height of from 5 m to 25 m, particularly from 200 mm to 1500 mm internal diameter and a height of from 10 m to 20 m, is preferred there.

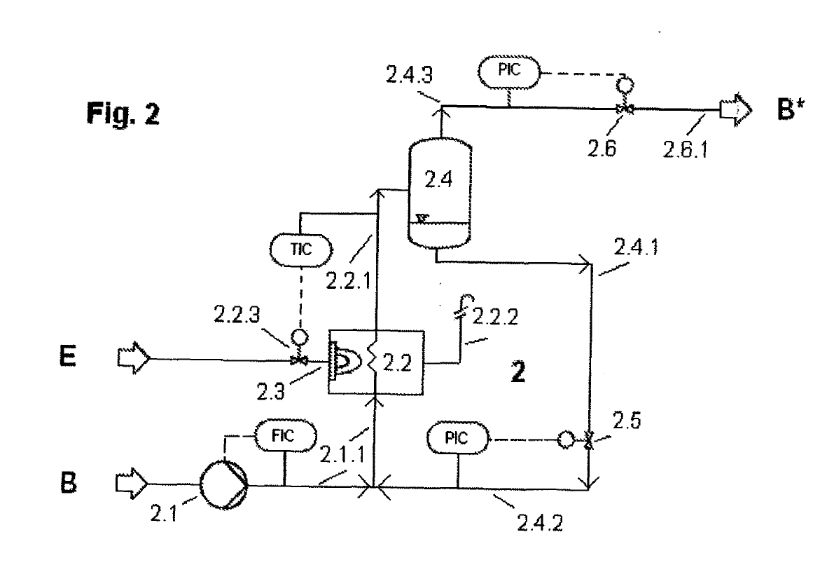

For start-up and uniform supply of a fluidized bed reactor unit (1) according to the invention with a heated starting material stream (B*), in particular STC, it is advantageous to use a (natural) gas-fired heater unit having a circulation (2) (cf. for example FIG. 2), wherein the substantially STC-containing chlorosilane stream (B) can be heated from about 20° C., i.e. ambient temperature, to a temperature of 650° C. at a pressure of from 25 to 55 bar and the unit (2) is based on a chlorosilane feed (B), in particular of STC, by means of pump (2.1), a gas-fired heat exchanger vessel (2.2), together with gas burner (2.3), at least one expansion vessel with condensate recycling/buffer container (2.4) including condensate regulation (2.5) and at least one metering unit (2.6), unit (2.1) being connected by pipe (2.1.1) to unit (2.2), furthermore pipe (2.2.1) connecting the heat exchanger (2.2) on the exit side to unit (2.4), it being possible here to recycle any resulting condensate and/or STC vapor (circulating procedure) via a pipe (2.4.1) or (2.4.2) to the pipe (2.1.1) and it being possible to meter heated chlorosilane or STC vapor (B*) from the unit (2.4) via pipe (2.4.3) and a control unit (2.6) and pipe (2.6.1) into the bottom (1.4) of the reactor unit (1).

FIG. 2 shows a preferred embodiment of a gas-fired heater for chlorosilanes for start-up and targeted uniform supply of a reactor up to a temperature of 650° C. at a pressure up to 55 bar, in particular for heating a substantially STC-containing chlorosilane feed for supplying an existing fluidized bed reactor.

The chlorosilane heater for start-up and supply of the fluidized bed unit (1) or (1.4) with chlorosilane (B*), in particular with an STC-containing chlorosilane stream, can, however, also be designed or implemented as described in the still unpublished parallel application PCT/EP2008/053079 with the title “Method for the gradual temperature control of chemical substances with defined input and output temperatures in a heater and device for carrying out said method”.

The fluidized bed reactor (1) or (1.1) is advantageously supplied via a fluidizing base for feeding in (B or B*) (1.4), the fluidized bed being started up via the volume flow and the height of fill of components (A) in the reactor (1.1) and the average residence time of the gaseous product mixture in the reactor being substantially regulated. The fluid dynamics in the reactor (1.1) can advantageously be additionally improved by the use of at least one sieve tray in the region above the feed (1.4) in the reactor or a sieve tray system which may comprise beds and/or baffles.

A fluidized bed reactor (1) according to the invention is preferably equipped with at least one gas metering unit for H₂ (C) (1.5.4) and HCl and/or chlorine gas (D) (1.5.2) for supplying the feeds (1.5).

A flammable gas (E), preferably natural gas, is suitably used for firing a heater, such as (2.2) or (1.11).

The waste heat from the combustion chamber unit (2.2), removed via (2.2.2), can advantageously be used advantageously for preheating gas streams (F) and/or, by means of heat exchangers (1.5.5), for preheating (C) and/or (D) containing gas streams.

Furthermore, a fluidized bed reactor (1) according to the invention can advantageously comprise a dust separation (1.7), the dust separation being substantially based on filtration for the chlorosilane-containing product mixture obtained in the fluidized bed reactor and removed at the top of the reactor.

For separating the product mixture into the material streams (G) and (H), a separation unit (1.8) is to be provided in a suitable manner in the fluidized bed reactor (1) according to the invention, the material stream (H) being obtained as condensate and the material stream (G) being removed in gaseous form. Uncondensed chlorosilanes can advantageously be recycled together with the hydrogen into the (hydrogenation) reactor (1.1).

The plant parts of the fluidized bed reactor according to the invention (cf. inter alia FIG. 1), including chlorosilane or STC heater (cf. inter alia FIG. 2), which are in contact with starting material, reaction or product streams, can, for example, be produced advantageously—but not exclusively—by means of highly heat-resistant black steels, such as 1.7380 or 1.5415, but preferably in the higher temperature range from stainless steel alloys of the series 1.4306, 1.4404, 1.4571 or 1.4876H.

The present invention also relates to a process for the industrial continuous preparation of a trichlorosilane (TCS)-containing product stream by reacting substantially silicon (Si) (A), chlorosilanes, in particular silicon tetrachloride (STC), (B) and hydrogen (H₂) (C) and optionally hydrogen chloride gas (HCl) and/or chlorine gas (Cl₂) or a mixture of hydrogen chloride and chlorine gas (D) at a pressure of from 25 to 55 bar and a temperature of from 450 to 650° C., preferably from 35 to 45 bar and from 550 to 620° C., in particular from 38 to 42 bar and from 580 to 610° C., and optionally in the presence of at least one catalyst, preferably based on at least one transition metal element, particularly preferably at least one from the series consisting of Fe, Co, Ni, Cu, Ta, W, such as FeCl₂, CuCl, CuCl₂, and/or the corresponding metal silicides, in particular a copper-based catalyst system, by
supplying a fluidized bed reactor according to any one of claims 1 to 9 to an extent of from ⅛ to ¾ of its reaction space with particulate silicon (A), it being possible optionally to mix catalyst with the components (A),
metering at the bottom a defined volume stream, preheated by means of a gas burner-fired heat exchanger, of at least one higher chlorosilane of the formula HₙSiCl₄₋ₙ where n=0, 1, 2 or 3, i.e. substantially preferably monochlorosilane, dichloro-silane, trichlorosilane and in particular silicon tetrachloride or a mixture of the above-mentioned chlorosilanes (B*),
metering hydrogen gas (C) and optionally hydrogen chloride gas and/or chlorine gas (D) in a targeted manner into the volume stream of chlorosilane or silicon tetrachloride or into the lower part of the reactor, but below the height of the silicon bed of the reactor, at one or more points,
removing the product mixture obtained in the reaction at the top of the reactor and passing it via a dust separation at a temperature above 400° C. and a pressure of from 25 to 55 bar,
cooling the product stream substantially freed from dust fractions, preferably under 35 bar and under 150° C., condensing chlorosilanes, in particular trichlorosilane, (H), removing excess gas fractions (G) from the product stream, preferably recycling them into the plant, and
subsequently metering the silicon fraction removed via the product stream from the reactor by at least one feed which is arranged in the upper part of the reactor above the height of the silicon bed of the reactor.

In the process according to the invention, preferably from 1 to 5 mol of H₂ (C), particularly preferably from 1.1 to 2 mol of H₂, are used per mole of SiCl₄ (B).

Particularly advantageously, from 0 to 1 mol of HCl (D), preferably from 0.001 to 0.7 mol of HCl, particularly preferably from 0.01 to 0.5 mol of HCl, very particularly preferably from 0.1 to 0.4 mol of HCl, in particular from 0.2 to 0.3 mol of HCl, is used for a procedure which is as energy-independent as possible in the process according to the invention.

Surprisingly, from 0 to 1 mol of Cl₂ (D), preferably from 0.001 to 0.5 mol of Cl₂, particularly preferably from 0.01 to 0.4 mol of Cl₂, in particular from 0.1 to 0.3 mol of Cl₂, per mole of H₂ (C) can also advantageously be used for a procedure which is as energy-independent as possible.

A gas mixture comprising HCl and Cl₂ in a molar ratio of HCl to Cl₂ of from 0:1 to 1:0, preferably from 0.01:0.99 to 0.99:0.01, can also be suitably used as component (D).

In addition, an average residence time of the gas or vapor mixture in the reactor of from 0.1 to 120 seconds, preferably from 0.5 to 100 seconds, particularly preferably from 1 to 60 seconds, very particularly preferably from 3 to 30 seconds, in particular from 5 to 20 seconds, is advantageously ensured in the process according to the invention.

Compared with the process according to the invention, it was necessary to date according to the prior art, in the endothermic hydrogenation reaction of STC to give TCS, to supply the necessary quantity of energy to the reactor via electric heating.

Furthermore, it is advantageous if, in the process according to the invention, the reaction temperature for the reaction in the reactor interior is monitored and this is regulated at a constant hydrogen/STC ratio by the metering of HCl and/or Cl₂ (D) and/or the reaction temperature for the reaction in the reactor (1.1) is controlled or additionally regulated via the units (1.2) and (1.3) with the use of the medium (F) and of the units (1.9) or (1.11). The quantity of heat to be supplied or removed can advantageously be regulated by the double jacket (1.2) and the internal heat exchanger unit (1.3) including the units (1.9) and (1.11). For example—but not exclusively—air or an inert gas, such as nitrogen, or a noble gas, such as argon, can be used as medium (F).

Furthermore, a—generally commercially available—metallurgical silicon having a mean particle size of from 10 to 3000 μm, preferably from 50 to 2000 μm, particularly preferably from 80 to 1500 μm, very particularly preferably from 100 to 1000 μm, in particular from 120 to 500 μm, is advantageously used as silicon (A) in the process according to the invention. The silicon (A) used here preferably has a purity greater than or equal to 80%, particularly preferably greater than or equal to 90%, in particular greater than or equal to 98%.

At least one catalyst can advantageously be mixed with the silicon (A) by thoroughly mixing the silicon and the catalyst system, in particular by milling the silicon and the catalyst together beforehand. For this purpose, milling methods known per se to the person skilled in the art can be used. In addition, dust (J) from the unit (1.7) can advantageously be recycled to the silicon or, in the case of the preparation of a mixture of silicon and catalyst, at least proportionately recycled.

As a rule, the process according to the invention is carried out as follows:

The reactor and the starting material- or product-transporting pipes of the plant are as a rule dried and rendered inert before the start of operation, for example by flushing the plant with a preheated inert gas, such as argon or nitrogen, until the proportion of oxygen tends to zero at the outlet.

For the start-up and subsequent uniform and continuous supply with a heated starting material stream (B*), a unit (2), i.e. a gas-fired chlorosilane heater having a circulation, is preferably connected upstream of the fluidized bed reactor (1) according to the invention, in which unit (2) the substantially STC-containing starting material stream (B) can be heated from about 20° C. to a temperature up to 650° C. and a pressure from to 55 bar and, in addition to control units and pressure-resistant pipes, the unit (2) is substantially based on a so-called feed pump (2.1) and on a gas-fired heat exchanger vessel (2.2) with gas burner (2.3) and expansion vessel with condensate recycling (2.4), the hot fumes in the combustion vessel flowing around at least one pressure-resistant pipe which serves for transporting the chlorosilane or STC stream (B). Furthermore, this unit comprises a suitable arrangement for a circulation procedure for uniform heating of the chlorosilane or STC stream (cf. FIG. 2). For this purpose, for example, the SiCl₄, which is suitably removed from a tank, can be compressed by means of a piston diaphragm pump (2.1) to about 40 bar. The SiCl₄ can pass via pipe (2.1.1) into the first heating coil sections of the heater (2.2) fired with natural gas. Suitably present above this is a level-controlled expansion vessel which circulates a resulting chlorosilane or STC liquid phase via the controller unit (2.5) adapted with regard to the prevailing pressure back into the chlorosilane or STC stream of the pipe (2.1.1). Chlorosilane or STC vapor (B*) heated in a targeted and well-defined manner can be removed from the gas space of the expansion vessel and supplied as feed via the control unit (2.6) and the pipe (2.6.1) and the chlorosilane feed (1.4) to the reactor (1.1), advantageously in a well-metered, preferably continuous volume stream. Thus, the buffer container (2.4) advantageously also serves for compensating pressure variations and providing the superheated chlorosilane or SiCl₄ with temperature and pressure regulation for the continuous operation of the fluidized bed reactor (1). Moreover, a chlorosilane stream, in particular an STC stream, which occurs in a parallel or subsequent process, can advantageously be used at least proportionately as feed stream (B) for the chlorosilane heater present. Combustion vessel and buffer vessel of the chlorosilane heater and associated pipes for transporting chlorosilanes, in particular tetrachlorosilane, are as a rule made of highly heat-resistant black steels, such as 1.7380 or 1.5415, but preferably in the higher temperature range of stainless steel alloys of the series 1.4306, 1.4404, 1.4571 or 1.4876H. Such a heater apparatus for chlorosilanes can be used in a particularly advantageous manner in a plant for the production of trichlorosilane or of particularly pure polycrystalline silicon. Thus, the use of such a gas-fired chlorosilane heater unit, in particular having a natural gas burner, particularly advantageously permits the saving of an expensive electrical heating of the chlorosilane or STC phase; this applies both to the procurement costs and in particular to the high operating costs of an electrically operated heater. In contrast to electrically heated heaters, the heater system directly fired with natural or heating gases can react more rapidly to load change since long-lasting heat-up and subsequent heating effects are absent. In the case of a particularly favorable design of the heater, the hot waste gases can also be fed repeatedly via the heater in order to achieve further savings in operating costs. Furthermore, in the case of interruption of operation or stoppage of the reaction, it is possible to switch to a circulation mode which enables the vessel or the heater to be kept in readiness without loss of time for long heat-up times. A chlorosilane or STC stream (B*) thus heated predominantly to supercritical conditions is advantageously metered into the fluidized bed reactor (1), the reactor (1.1) being filled with milled silicon powder (A), preferably to an extent of ⅛ to ¾ of the reactor volume, particularly preferably to an extent of ¼ to ⅔, in particular to an extent of ⅓ to ½, and the is fluidized by the targeted treatment with the heated chlorosilane stream (also referred to as fluidized bed for short). In the process according to the invention, the reaction takes place as a rule in the temperature range from 400° to 650° and at a pressure of from 25 to 55 bar. The reactor according to the invention advantageously has a double jacket with internally welded-on ribs. These increase the heat transfer area and simultaneously ensure a guided flow of the medium. By means of a fan, it is possible to transport air or inert gases (F) through this double jacket. Reactors having a relatively large diameter may additionally contain suitable internals, which are likewise provided with ribs and through which the gas flows. This gas can advantageously be adjusted to any desired temperature by a gas burner (cf. (1.11)). It is thus possible to heat the reactor (1.1) very uniformly in a manner gentle to the material to the necessary operating temperature on start-up. This can be realized, according to the invention, in a substantially more economical manner than with electrical heating. After the operating temperature has been reached, the hydrogenation reaction is started by targeted addition or metering of hydrogen and optionally HCl and/or Cl₂ gas into the silicon bed with further supply of energy by means of heat-transfer medium (F), which is heated by gas firing. Thus, the exothermic hydrochlorination reaction of the silicon can be started in particular by the addition of HCl (gas). The addition of HCl can be increased in a targeted manner until a temperature increase is observable in the reactor. Thus, a virtually energy-independent hydrogenation of STC present can be carried out in an advantageous manner. After initiation of the reaction, the burner power can as a rule be reduced and the reactor temperature program can transfer from the heating mode to the cooling mode. By means of the cooling, it is possible to ensure that the reactor material is not damaged by local overheating. Furthermore, a back reaction to STC can advantageously be reduced by cooling, in particular in the space above the fluidized bed in the interior of the reactor. Product mixture formed by the reaction can be removed via the top of the reactor and substantially freed from Si and, if desired, catalyst dust in a suitable manner by means of a dust filter. The collected dust (J) can be recycled as an additive via component (A). The product stream is subsequently cooled in a suitable manner, gas phase and TCS/STC liquid phase (H) being obtained. The gas phase (G) can advantageously be recycled via a separate feed, preferably in the lower part of the reactor. The separation of the product stream (H) into TCS and recyclable STC can be effected, for example, by distillation. The proportion of silicon or spent silicon transported in the product stream via the top of the reactor is metered in a suitable manner via the solid feed (1.6) into the reactor.

The present invention therefore also relates to the use of an apparatus according to the invention for the hydrogenation of higher chlorinated silanes of the formula HₙSiCl₄₋ₙ where n=0, 1, 2 or 3, preferably for the preparation of chlorosilanes of the formula HₙSiCl₄₋ₙ where n=1, 2, 3 or 4 which have a low degree of chlorination, in particular for the preparation of trichlorosilane.

Particularly advantageously, an apparatus according to the invention (also referred to below as fluidized bed stage for short) can be used in an integrated system for the preparation of chloro- or organosilanes, pyrogenic silica and/or high purity silicon for solar and electronic applications.

Thus, the present invention also relates to the use of an apparatus according to the invention (also referred to below as fluidized bed stage for short) in an integrated system for the preparation, known per se, of silanes and organosiloxanes, in particular chloro- or organosilanes, such as monosilane, monochlorosilane, dichlorosilane, trichlorosilane, silicon tetrachloride, vinyltrichlorosilane, substituted or unsubstituted C3-18-alkylchlorosilanes, such as 3-chloropropyltri-chlorosilane, propyltrichlorosilane, trimethoxysilane, triethoxysilane, tetramethoxysilane, tetraethoxysilane, vinyltrialkoxysilane, substituted or unsubstituted C3-18-alkylalkoxysilanes, such as propyltrialkoxy-silane, octyltrialkoxysilanes, hexadecyltrialkoxy-silane, chloroalkylalkoxysilanes, such as 3-chloro-propyltrialkoxysilane, fluoroalkylalkoxysilanes, such as tridecafluoro-1,1,2,2-tetrahydrooctyltrialkoxy-silane, aminoalkylalkoxysilanes, methacryloyloxyalkyl-alkoxysilanes, glycidyloxyalkylalkoxysilanes, poly-etheralkylalkoxysilanes, alkoxy being in each case, for example, methoxy and ethoxy, to mention but a few, and subsequent products thereof, chlorosilane streams, in particular STC-containing streams, being recycled at least proportionately into the process stages for the preparation of pyrogenic silica and for the preparation of chlorosilanes in the fluidized bed.

Trichlorosilane obtained in the fluidized bed stage according to the invention and subsequently purified is preferably used for the preparation of monosilane by dismutation, the silicon tetrachloride obtained in the dismutation being recycled at least proportionately into the monosilane process and/or it being fed at least proportionately to the STC heater of the fluidized bed reactor according to the invention. Monosilane thus obtained can advantageously be used for the preparation of polycrystalline silicon (solar grade) by thermal decomposition of monosilane. Furthermore, the hydrogen occurring in the thermal decomposition of the monosilane can advantageously be recycled into the fluidized bed stage according to the invention in the integrated system.

Thus, according to the invention, an apparatus and a substantially energy-independent process for the preparation of trichlorosilane starting from metallurgical silicon, silicon tetrachloride and hydrogen and optionally HCl and/or Cl₂ and optionally in the presence of a catalyst can be provided and particularly advantageously used—as shown above—in a particularly economical manner with simultaneously high yield and with a gentle procedure for the material of the reactor.

### LEGEND FOR FIGS. 1 AND 2

1 Fluidized bed reactor
1.1 Reactor (casing)
1.2 Heat exchanger jacket
1.3 Heat exchanger internals
1.4 Chlorosilane feed (B or B*)
1.5 Feed (gas metering) for components (C) and/or (D)
1.6 Solid feed (metering) for component (A)
1.7 Dust filter
1.8 Condenser
1.9 Fan (blower)
1.10 Hot gas recuperator
1.11 Gas-fired heat exchanger (combustion chamber)
2 Chlorosilane heater with circulation (heater)
2.1 (Liquid) pump for component (B)
2.2 Gas-fired heat exchanger vessel (combustion chamber)
2.3 Gas burner
2.4 Expansion vessel with condensate recycling/buffer container
2.5 Condensate regulation (condensate control valve)
2.6 Pressure control valve (metering unit for heated chlorosilane stream)

1. A fluidized bed reactor comprising
a fluidized bed reactor unit comprising
a reactor casing comprising a jacket which cools or warms the reactor and a heat exchanger unit arranged parallel to a longitudinal axis of the reactor and in an interior of the reactor, optionally with a gaseous medium flowing through the jacket and the heat exchanger unit and the gaseous medium optionally being heated by at least one gas-fired heat exchanger;
at least one bottom feed for a chlorosilane- or silicon tetrachloride-comprising starting material stream;
at least one gaseous starting material feed for at least one gaseous starting material selected from the group consisting of hydrogen, hydrogen chloride, and chlorine;
at least one particulate feed for particulate silicon which is optionally mixed with catalyst; and
a removal and separation unit for at least one product via a reactor top,
a dust filter; and
a condenser,
wherein the fluidized bed reactor is suitable for continuous hydrogenation of at least one higher chlorosilane of formula HₙSiCl₄₋ₙ where n=0, 1, 2 or 3 in the presence of silicon.

2. The fluidized bed reactor of claim 1, further comprising:
a waste heat exchanger for available waste heat for preheating at least one gas stream of the gaseous medium.

3. The fluidized bed reactor of claim 1, further comprising: a gaseous starting material heat exchanger which employs available waste heat for preheating streams of the at least one gaseous starting material.

4. The fluidized bed reactor of claim 1, further comprising:
a chlorosilane heating unit for start-up and uniform supply of the fluidized bed reactor unit with a heated chlorosilane- or silicon tetrachloride-comprising stream, wherein the chlorosilane- or silicon tetrachloride-comprising, starting material stream is optionally heated from about 20° C., i.e. ambient temperature, to a temperature up to 650° C. at a pressure of from 25 to 55 bar,
wherein the chlorosilane heating unit comprises: a chlorosilane feed with a feed pump;
a gas-fired heat exchanger vessel;
together with a gas burner;
at least one expansion vessel/buffer container; and
at least one metering unit,
wherein the feed pump is connected via at least one first pipe to the gas-fired heat exchanger vessel, at least one second pipe connecting the gas-fired heat exchanger vessel on an exit side to the at least one expansion vessel/buffer container, wherein any resulting condensate and/or chlorosilane vapor is optionally recycled (circulating procedure) via at least one third or fourth pipe to the at least one first pipe; and
optionally metered from the at least one expansion vessel/buffer container via at least one fifth pipe and the at least one metering unit and at least one sixth pipe into the at least one bottom feed of the fluidized bed reactor unit.

5. The fluidized bed reactor of claim 1, further comprising a fluidizing base for feeding the chlorosilane- or silicon tetrachloride-comprising stream into the fluidized bed reactor unit.

6. The fluidized bed reactor of claim 1, further comprising:
at least one gas metering unit for H₂ and at least one of HCl and chlorine gas for supplying the at least one gaseous starting material feed.

7. The fluidized bed reactor of claim 1, further comprising:
a dust separation,
wherein the dust separation is substantially based on filtration of a chlorosilane mixture obtained in the fluidized bed reactor and removed at a top of the fluidized bed reactor.

8. The fluidized bed reactor of claim 1, further comprising:
a separation unit for separating a gaseous form material streams and a condensate material stream,
wherein the condensate material stream is obtained as condensate and the gaseous form material stream is removed in gaseous form.

9. The fluidized bed reactor of claim 1, wherein the reactor casing has an internal diameter of from 100 mm to 2000 mm and a height of from 5 m to 25 m.

10. A process for the continuous preparation of a trichlorosilane (TCS)-comprising product stream, the process comprising
supplying a fluidized bed rector of claim 1 to an extent of ⅛ to ¾ of its reaction space with particulate silicon, optionally mixing catalyst with the particulate silicon;
metering at the bottom a defined volume stream, preheated by a gas burner-fired heat exchanger, of silicon tetrachloride;
metering hydrogen gas, and optionally at least one of hydrogen chloride gas and chlorine gas, in a targeted manner into the defined volume stream of silicon tetrachloride or into a lower part of the reactor, but below a height of a silicon bed of the reactor, at one or more points;
removing a reaction product mixture obtained at a top of the reactor and passing it onward via a dust separation at a temperature above 400° C. and a pressure of from 25 to 55 bar, to obtain a product stream;
cooling the product stream substantially freed from dust fractions, condensing chlorosilanes, removing excess gas fractions from the product stream; and
subsequently metering a silicon fraction removed via the product stream from the reactor by at least one feed which is arranged in an upper part of the reactor above the height of the silicon bed of the reactor,
wherein the process continuously prepares the (TCS)-comprising product stream by reacting substantially
(A) silicon (Si),
(B) silicon tetrachloride (STC),
(C) hydrogen (H₂), and, optionally,
(D) at least one selected from the group consisting of hydrogen chloride gas (HCl) and chlorine gas (Cl₂),
at a pressure of from 25 to 55 bar and a temperature of from 450 to 650° C. and optionally in the presence of at least one catalyst.

11. The process of claim 10, wherein from 1 to 5 mol of H₂ (C) are employed per mole of SiCl₄ (B).

12. The process of claim 10, wherein from 0 to 1 mol of HCl (D) is employed per mole of H₂ (C).

13. The process of claim 10, wherein from 0 to 1 mol of Cl₂ (D) is employed per mole of H₂ (C).

14. The process of claim 10, wherein a gas mixture comprising HCl and Cl₂ in a molar ratio of HCl to Cl₂ of from 0:1 to 1:0 is employed as (D).

15. The process of claim 10, wherein a reaction temperature for reaction in an interior of the fluidized bed reactor is monitored and the reactor temperature is regulated at a constant hydrogen/STC ratio by a metering of at least one of HCl and Cl₂ (D) and/or the reaction temperature for the reaction in the reactor casing is controlled or additionally regulated via the jacket and the heat exchanger unit with a heat exchange medium (F) and a fan or the at least one gas fired heat exchanger.

16. The process of claim 10, wherein a metallurgical silicon having a mean particle size of from 10 to 3000 μm is employed as silicon (A).

17. The process of claim 10, wherein at least one catalyst is mixed with the silicon (A), and the silicon and the at least one catalyst are thoroughly mixed.

18. A method of hydrogenating of at least one higher chlorinated silane, the method comprising contacting the at least one higher chlorinated silane with hydrogen in the fluidized bed reactor, of claim 1, wherein the at least one higher chlorinated silane has a formula HₙSiCl₄₋ₙ where n=0, 1, 2, or 3.

19. The method of claim 18₁ in an integrated system, wherein at least one selected from the group consisting of a silane, an organosiloxane, a precipitated silica, a pyrogenic silica, and a high-purity silicon is prepared.

20. The method of claim 19, wherein the at least one higher chlorinated silane or a corresponding mixture of higher chlorinated silanes occurring in the integrated system is at least proportionately recycled into process stages for preparing pyrogenic silica and for rearing at least one chlorosilane in the fluidized bed.

21. The method of claim 19, wherein trichlorosilane is obtained in a fluidized bed stage and is employed, after further purification, for preparing monosilane by dismutation, and silicon tetrachloride obtained in the dismutation is recycled at least proportionately into the process by feeding it at least proportionately to a chlorosilane or STC heater.

22. The method of claim 21, wherein the monosilane is obtained by dismutation from trichlorosilane which is obtained in a fluidized bed stage, and
the monosilane is subsequently thermally decomposed to prepare polycrystalline silicon of solar grade.

23. The method of claim 22, wherein hydrogen produced in the thermally decomposing of monosilane is recycled into the fluidized bed stage in the integrated system.

24. The fluidized bed reactor of claim 1, which is suitable for preparing at least one chlorosilane by reacting substantially
(A) silicon (Si),
(B) silicon tetrachloride (STC),
(C) hydrogen (H₂), and, optionally,
(D) at least one selected from the group consisting of hydrogen chloride gas (HCl) and chlorine gas (Cl₂),
at a pressure of from 25 to 55 bar and a temperature of from 450 to 650° C. and optionally in the presence of at least one catalyst.
